(19) United States
(12) Patent Application Publication
(10) Pub. No.: US 2008/0244864 A1
(43) Pub. Date: Oct. 9, 2008

(54) Hinge for folding container

(75) Inventor: Renbin YI, Shenzhen (CN)

Correspondence Address: WORKMAN NYDEGGER, 60 EAST SOUTH TEMPLE, 1000 EAGLE GATE TOWER, SALT LAKE CITY, UT, 84111, US

(73) Assignee: CHINA INTERNATIONAL MARINE CONTAINERS (GROUP) LTD., Shenzhen (CN)

(21) Appl. No.: 11/831,808

(22) Filed: Jul. 31, 2007

(30) Foreign Application Priority Data
Aug. 1, 2006 (CN) 200610061968.0

(51) Int. Cl. E05D 7/00

(52) U.S. Cl. 16/221

(57) ABSTRACT

A hinge for folding container comprises an inner hinge, an outer hinge and a locking device for locking the inner and outer hinge. Wherein, the inner hinge and the outer hinge are pivotally connected by a pivot pin, the outer hinge comprises at least two outer hinge plates provided in parallel, and the inner hinge comprises at least two inner hinge plates provided in parallel. Compared with the prior art, without changing the standard operating hole, the hinge for folding container disclosed by the present invention can widen the transverse width of the inner hinge, and so that the rigidity of the inner hinge is effectively enhanced. Therefore, the hinge according to the present invention can be applied to any types of folding container, especially the folding container mounted with an independent corner post.

### FIELD OF THE INVENTION

The present invention relates to components of large-scale rigid folding container, and in particular, relates to components of folding container, especially, a hinge for folding container.

### BACKGROUND OF THE INVENTION

In the field of containers, folding containers are widely applied because of small space after folding, low transportation cost of empty containers and convenience of loading and unloading cargo.

As early as in middle 70s', the folding containers have been designed, researched and applied, but the temporal folding containers are reconstructed from dry freight containers, when loaded, the folding container is used as a complete dry freight container; and when unloaded, the roof panel is removed, the two side walls are folded inward respectively, on top of which the roof is laid, and then the two end walls are folded inward. Such temporal folding containers save unloading transportation cost, but due to complicated operation, such type of the containers is not popular. Till later 70s', the hinge for folding containers was successfully launched, the folding container gets widely applied.

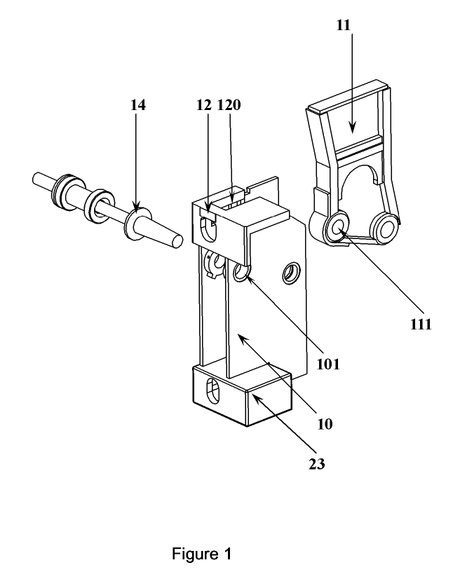

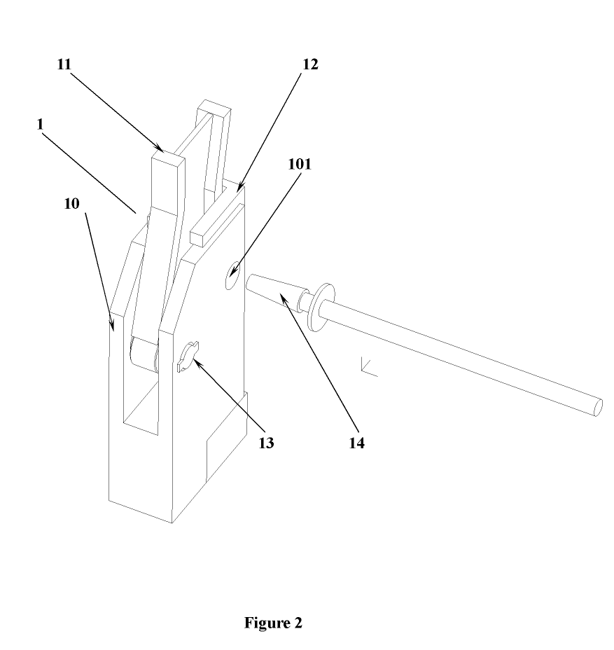

As shown in FIGS. 1 and 2, a hinge 1 for currently common used folding container, comprises an outer hinge 10 composed of two parallel plates, an inner hinge 11 provided within the outer hinge and connected with the outer hinge 10 through a pivot pin 13, a hinge top plate 12 provided on top of the outer hinge 10, and a taper pin 14 for locking the inner hinge 11 and the outer hinge 10. A hinge top plate 12 is provided with an aperture 120 for housing the inner hinge 11, while not housing the inner hinge 11, the aperture 120 is used to place an ISO twist lock device for container to interlocking containers, and whose width is around 60 mm. Taper holes 101 and 111 are provided on the outer hinge 10 and inner hinge 11 correspondingly, when needed, the taper pin 14 gets through the taper holes 101 and 111, to lock the inner hinge 11 and outer hinge 10. In order to easier use the folding container, a bottom corner fitting 23 is welded at the bottom of the outer hinge generally.

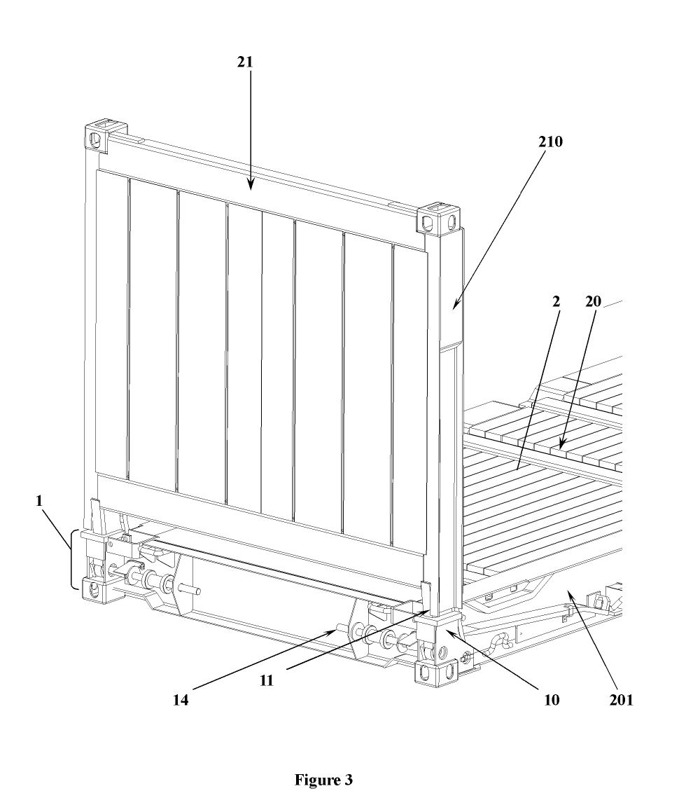

As shown in FIG. 3, when installing the hinge 1 in the folding container, the outer hinge 10 is welded with a bottom side rails 201 that is at the two sides of a base 20 of the container 2, the top of the inner hinge 11 is welded with the bottom of the corner post 210 that is at the two sides of an end wall 21. When the end wall 21 erects, the taper pin 14 locks the inner and outer hinge, so that the gap between the inner and outer hinge is quite small, which perfectly ensures the stability of the erecting end wall.

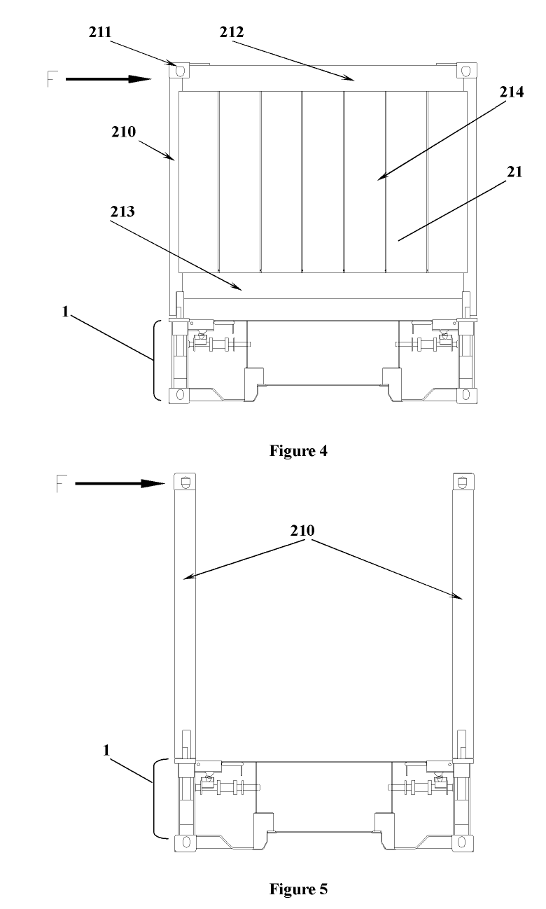

In the whole structure of the folding container, the end wall functions to pile, lift form load space together with base, and prevent cargos from longitudinal sliding. A common end wall as shown in FIG. 4, comprises corner posts 210 at the two sides thereof, a top corner section 211 welded on top of the corner posts 210, an header 212 breadthwise welded on top of the two corner posts 210, an sill 213 breadthwise welded at bottom of the two corner posts, and an end wall panel 214 whose four sides are welded with the corner posts 210, the header 212, and the sill 213 respectively. During the transportation of the container, the end wall suffers from transverse thrust. For the end wall 21 as shown in FIG. 4, the structure of the end wall is complete and the components are connected by weld each other, therefore, when the top of the end wall suffers from transverse thrust F, the transverse rigidity of the hinge 1 can satisfy the requirement. However, the structure of the end wall as shown in FIG. 5, has only corner posts 210 located at two sides thereof (such corner post, which bears the transverse thrust alone, is called independent corner post), and the top of the corner post 210 suffers force F, then the transverse rigidity of the hinge 1 can hardly satisfy the requirement. Herein, because the width of the aperture 120 on the hinge top plate 12 is around 63 mm, it is almost impossible to enhance the inner hinge along the width direction to satisfy the usage requirement.

### SUMMARY OF THE INVENTION

Against the deficiency of the prior art, the object of the present invention is to provide a hinge for folding container that satisfies folding corner posts of the folding container and enhances the transverse rigidity thereof.

In order to realize the above object, the present invention applies the following technical solution:

A hinge for folding container comprises an inner hinge, an outer hinge and a locking device for locking the inner and the outer hinge; wherein, the inner hinge and the outer hinge are pivotally connected by a pivot pin, the outer hinge comprises at least two outer hinge plates provided in parallel, and the inner hinge comprises at least two inner hinge plates provided in parallel.

The hinge for folding container as mentioned above, wherein, a hinge top plate is provided on the top of the outer hinge, and two slots for housing the two inner hinge plates are provided in parallel on the hinge top plate along the breadth direction of the container inside and outside.

The hinge for folding container as mentioned above, wherein, the hinge top plate is in a shape of upside-down “L”.

The hinge for folding container as mentioned above, wherein, the width of the slots inside the container matches the width of an ISO standard twist lock for container; or the width of the slots outside the container matches the width of an ISO standard twist lock for container; even or the width of the slots inside and outside the container all match the width of an ISO standard twist lock for container.

The hinge for folding container as mentioned above, wherein, the top or bottom of the two inner hinge plates are connected by a boss or a connection plate as a whole, and so that an integral structure of the two inner hinge plates is formed.

The hinge for folding container as mentioned above, wherein, the top and bottom of the two inner hinge plates are all connected by a boss or a connection plate as a whole, and so that an integral structure of the two inner hinge plates is formed.

The hinge for folding container as mentioned above, wherein, a reinforcement plate is provided between the two outer hinge plates, the top of the reinforcement plate is fixed with the bottom surface of the outer hinge top plate and located between the two slots.

The hinge for folding container as mentioned above, wherein, the locking device is a taper pin, and corresponding taper holes are opened on the inner hinge plates and the outer hinge plates; when the inner hinge plates erect against the outer hinge, the taper pin is inserted into the taper holes to lock.

The hinge for folding container as mentioned above, wherein, the locking device is a square pin, and corresponding square slots are opened at the rear end of the inner hinge plates and the outer hinge plates; when the inner hinge plates erect against the outer hinge, the square pin is inserted into the square slots to lock.

Compared with the prior art, without changing the standard operating hole, the hinge for folding container disclosed by the present invention can widen the transverse width of the inner hinge, and so that the rigidity of the inner hinge is effectively enhanced. Therefore, the hinge according to the present invention can be applied to any types of folding container, especially the folding container mounted with independent corner post.

### DETAILED DESCRIPTION OF THE DRAWINGS

In order to further illustrate the technical means and effect of the present invention for realizing the predefined object, the present invention is detailed combining with the following figures. And the object, features and specifications of the present invention can be understood deeply and particularly hereafter. However, the figures are just for reference and illustration, not to limit the present invention.

The present invention is further detailed combining the figures and embodiments.

FIG. 1 shows the decomposing sketch of a general hinge according to the prior art;

FIG. 2 shows the structure sketch of a general hinge according to the prior art, wherein every portions of the general hinge are assembled;

FIG. 3 shows the structure sketch of a folding container according to the prior art;

FIG. 4 shows one structure sketch of the end of a folding container according to the prior art;

FIG. 5 shows another structure sketch of the end of a folding container according to the prior art;

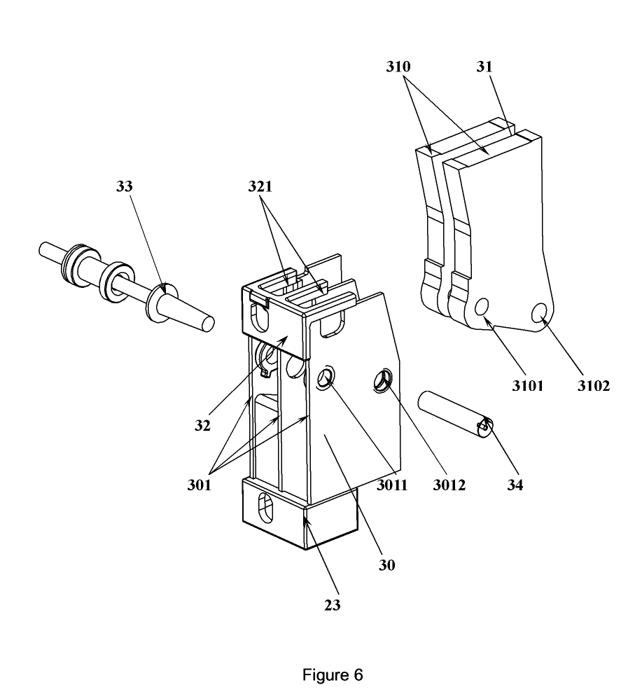

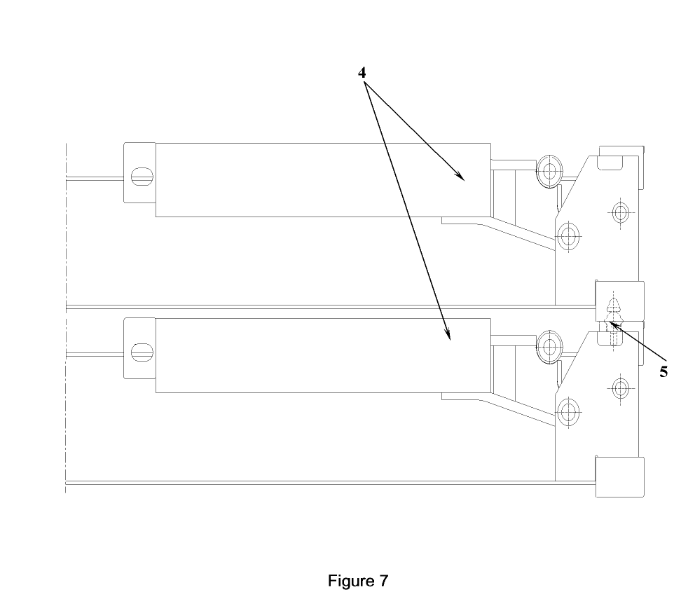

FIG. 6 shows the structure sketch of a hinge according to the first embodiment of the present invention;

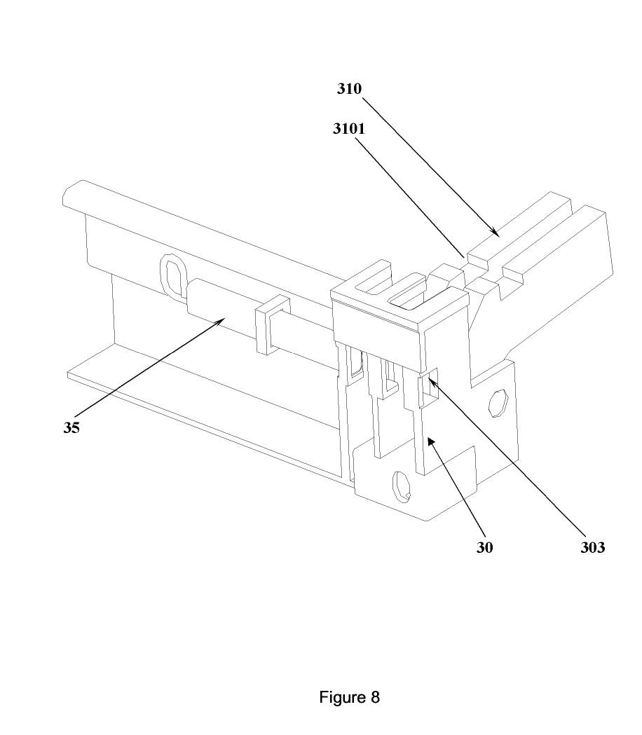

FIG. 7 shows the sketch of stacking general folding containers according to the prior art;

FIG. 8 shows the structure sketch of a hinge according to the second embodiment of the present invention;

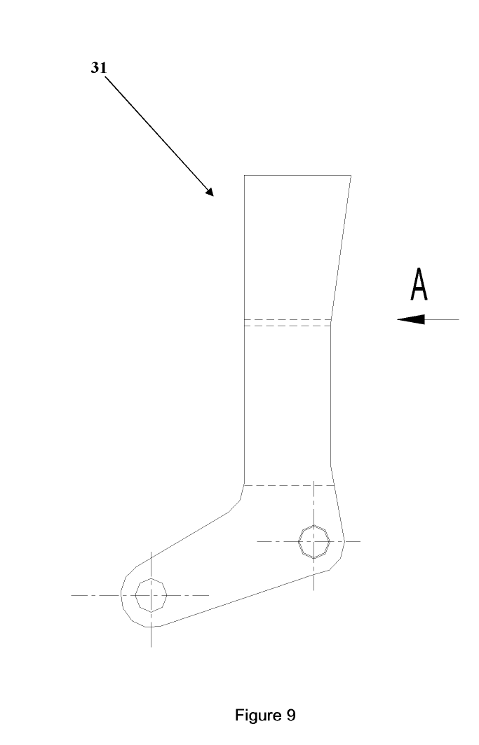

FIG. 9 shows the front view of the inner hinge plate for a hinge according to the third embodiment of the present invention;

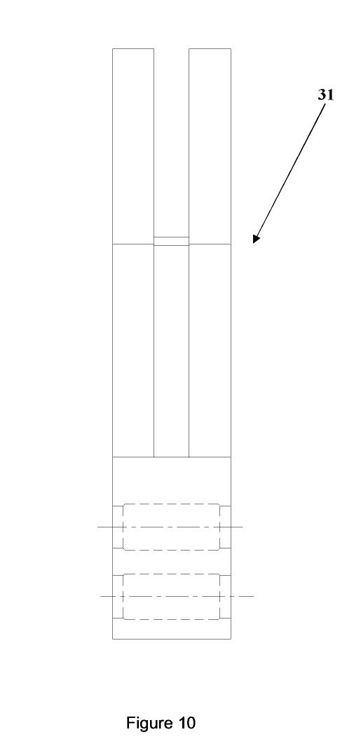

FIG. 10 shows the view from A for FIG. 9.

### DETAILED DESCRIPTION OF THE INVENTION

### Embodiment 1

As shown in FIG. 6, a hinge for folding container according to the present invention comprises an inner hinge 31 constituted by two inner hinge plates 310 provided in parallel with certain distance between each other, an outer hinge 30 constituted by two outer hinge plates 301 provided in parallel with certain distance between each other. Meanwhile, a reinforcement plate is provided between the two outer hinge plates to enhance. In the present embodiment, because the shape of the reinforcement plate is the same to the outer hinge plate 301, the reinforcement plate is simply named as outer hinge plate normally. A hinge top plate 32 is fixed on the top of the outer hinge 30, which is preferably in a shape of upside-down “L”. Two slots 321 for housing the two inner hinge plates 310 are provided in parallel on the hinge top plate 32 along the breadth direction of the container. When installing the hinge, the two inner hinge plates 310 are located between the three outer hinge boards 301 (including the two outer hinge plates and the reinforcement plate therebetween), a pin 34 is inserted into holes 3102 and 3012 opened on the inner hinge plate 310 and the outer hinge plate 301 respectively, and so that the inner hinge 31 and the outer hinge 30 are connected pivotally, meanwhile the inner hinge 31 is pivotal against the outer hinge 30 with the pin 34 as axis. When the inner hinge 31 erects against the outer hinge 30, the two inner hinge plates 310 can be located in the two slots 321 opened on the hinge top plate 32 respectively, meanwhile a cylindrical pin 33 may be inserted into taper holes 3101 and 3011 opened on the inner hinge plate 310 and the outer hinge plate 301 respectively, and so the lock between the inner hinge 31 and the outer hinge 30 is realized.

For the hinge according to the present embodiment, the thickness of one inner hinge plate is 60 mm, and the corresponding distance between the two outer hinge plates located aside thereof should be wider than 60 mm, in order to ensure the inner hinge plate can pivot between the outer hinge plates and enable the inner hinge plate can get through the hole opened on the hinge top plate at the same time, wherein the width of the hole matches the requirement of housing an ISO standard twist lock for container; however, the thickness of another inner hinge plate is variable, and similarly, the distance between the two outer hinge plates located aside thereof may match the thickness, and the width of the holes on the hinge top plate for housing the two inner hinge plates may match the thickness too. Furthermore, the two inner hinges can be connected by a boss or a connection plate, and so that the inner hinge is formed as a whole.

When the hinge according to the present embodiment is installed in the folding container, the outer hinge is welded with a bottom side rails along the two sides of the base of the folding container, and the top of the two inner hinge plates are welded with the bottom of a corner post along the two sides of the end wall. There are two modes for welding the two inner hinge plates with the bottom of the corner post: (1) after connected with each other, the top of the two inner hinge plates are welded with the bottom of the corner post; or (2) the two inner hinge plates are welded with the bottom of the corner post respectively (reference to FIG. 3). Meanwhile, as shown in FIG. 6, in order to easy the operation and protection of the folding container, a bottom corner fitting 23 is welded at the bottom of the outer hinge 30, herein all the three outer hinge plates 301 can be welded with the bottom corner fitting 23, or only the two outer hinge plates 301 aside the outer hinge are welded with the bottom corner fitting 23.

As shown in FIG. 7, when piling empty normal folding containers 4, in order to ensure the safety of the stack, the neighbor upper and lower containers are interlocked by an ISO standard twist lock 5 for container, which is located in the housing slot 120 of the hinge top plate 12 (as shown in FIG. 1), and whose top can be stuck in the bottom hole (not shown in figure) of the bottom corner fitting 23. In other words, in order to ensure the reliability of the interlock, the width of the housing hole 120 must satisfy the requirements of installing the ISO standard twist lock for container.

The hinge according to the present embodiment has two housing slots 321, and the width of at least one of the two housing slots satisfies the requirements of installing the ISO standard twist lock for container.

### Embodiment 2

FIG. 8 shows a hinge according to the second embodiment of the present invention. The structure of the hinge is similar to the embodiment 1, while modifications are made just on the structures of the inner hinge plate and the locking device. In particular, three square slots 3101 are opened at the rear end of the three inner hinge plates 310 correspondingly, and three square apertures 303 are opened at the rear end of the three outer hinge plates 30; when the inner hinge plates 310 erect against the outer hinge, a square pin 35 can be inserted into the square slots 3101 and the square apertures 303 to lock the inner hinge and the outer hinge.

### Embodiment 3

FIGS. 9 and 10 show a hinge according to the third embodiment of the present invention. The structure of the hinge is similar to the embodiment 1, while a modification is made just on the structure of the inner hinge 31. In particular, the bottoms of the two inner hinge plates are connected as a whole, and so that an integral structure of the inner hinge is formed. For the structure of the inner hinge that the bottom of the two inner hinge plates are connected as a whole, the corresponding outer hinge is composed of two outer hinge plates in parallel with certain distance between each other; and for housing the two inner hinge plates whose bottom are connected as a whole and top are separated, two housing slots are opened on a hinge top plate along the breadth direction of the container, wherein the hinge top plate is on the top of the outer hinge. Surely, in order to achieve an enhancement, according to the connection mode of the two inner hinge, an enhance board matching the two parallel outer hinge plates can be provided therebetween.

The above modification for the structure of the inner hinge may be embodied as: the top of the two inner hinge plates are connected as a whole, and so that an integral structure of the inner hinge is also formed. While for the structure of the inner hinge that the top of the two inner hinge plates are connected as a whole, the corresponding outer hinge is composed of two outer hinge plates in parallel with certain distance between each other, and for housing the two inner hinge plates whose top are connected as a whole and bottom are separated, two housing slots are opened on a hinge top plate along the breadth direction of the container, wherein the hinge top plate is on the top of the outer hinge. Surely, in order to achieve an enhancement, according to the connection mode of the two inner hinges, a reinforcement plate matching the two parallel outer hinge plates can be provided therebetween.

Additionally, the above modification for the structure of the inner hinge may be embodied as: the top and the bottom of the two inner hinge plates are all connected as a whole, and so that an integral structure of the inner hinge is also formed. The corresponding outer hinge, the top plate thereof and the setting of the reinforcement plate will not be detailed herein any more.

According to common knowledge, the present invention can be realized by other embodiments that fall within the spirit and scope of the principles of the disclosure. Therefore, the above are illustrations, for any perspective, which should not limit the implementations of the present invention, and numerous other modifications and embodiments can be devised in the art are all included by the present invention.

1. A hinge for folding container, comprising an inner hinge, an outer hinge and a locking device for locking the inner and the outer hinge, wherein, the inner and the outer hinge are pivotally connected by a pivot pin, and the outer hinge comprises at least two outer hinge plates provided in parallel, the inner hinge comprises at least two inner hinge plates provided in parallel.

2. The hinge for folding container according to claim 1, wherein, a hinge top plate is provided on the top of the outer hinge, and two slots for housing the two inner hinge plates are opened in parallel on the hinge top plate along the breadth direction of the container inside and outside.

3. The hinge for folding container according to claim 2, wherein, the hinge top plate is in a shape of upside-down “L”.

4. The hinge for folding container according to claim 2, wherein, the width of the slots inside the container matches the width of an ISO standard twist lock for container.

5. The hinge for folding container according to claim 3, wherein, the width of the slots inside the container matches the width of an ISO standard twist lock for container.

6. The hinge for folding container according to claim 2, wherein, the width of the slots outside the container matches the width of an ISO standard twist lock for container.

7. The hinge for folding container according to claim 3, wherein, the width of the slots outside the container matches the width of an ISO standard twist lock for container.

8. The hinge for folding container according to claim 2, wherein, a reinforcement plate is provided between the two outer hinge plates, the top of the reinforcement plate is fixed with the bottom surface of the outer hinge top plate and located between the two slots.

9. The hinge for folding container according to claim 3, wherein, a reinforcement plate is provided between the two outer hinge plates, the top of the reinforcement plate is fixed with the bottom surface of the outer hinge top plate and located between the two slots.

10. The hinge for folding container according to claim 2, wherein, the top and/or the bottom of the two inner hinge plates are connected as a whole to form an integral structure of the inner hinge.

11. The hinge for folding container according to claim 3, wherein, the top and/or the bottom of the two inner hinge plates are connected as a whole to form an integral structure of the inner hinge.

12. The hinge for folding container according to claim 10, wherein, the two inner hinge plates are connected by a boss or a connection plate.

13. The hinge for folding container according to claim 11, wherein, the two inner hinge plates are connected by a boss or a connection plate.

14. The hinge for folding container according to claim 1, wherein, the locking device is a taper pin, and corresponding taper holes are opened on the inner hinge plates and the outer hinge plates; when the inner hinge plates erect against the outer hinge, the taper pin is inserted into the taper holes to lock.

15. The hinge for folding container according to claim 2, wherein, the locking device is a taper pin, and corresponding taper holes are opened on the inner hinge plates and the outer hinge plates; when the inner hinge plates erect against the outer hinge, the taper pin is inserted into the taper holes to lock.

16. The hinge for folding container according to claim 3, wherein, the locking device is a taper pin, and corresponding taper holes are opened on the inner hinge plates and the outer hinge plates; when the inner hinge plates erect against the outer hinge, the taper pin is inserted into the taper holes to lock.

17. The hinge for folding container according to claim 1, wherein, the locking device is a square pin, and corresponding square slots are opened at the rear end of the inner hinge plates and the outer hinge plates; when the inner hinge plates erect against the outer hinge, the square pin is inserted into the square slots to lock.

18. The hinge for folding container according to claim 2, wherein, the locking device is a square pin, and corresponding square slots are opened at the rear end of the inner hinge plates and the outer hinge plates; when the inner hinge plates erect against the outer hinge, the square pin is inserted into the square slots to lock.

19. The hinge for folding container according to claim 3, wherein, the locking device is a square pin, and corresponding square slots are opened at the rear end of the inner hinge plates and the outer hinge plates; when the inner hinge plates erect against the outer hinge, the square pin is inserted into the square slots to lock.
